(19) United States
(12) Patent Application Publication
(10) Pub. No.: US 2009/0163402 A1
(43) Pub. Date: Jun. 25, 2009

(54) FABRIC SOFTENER

(75) Inventor: Scott Ellery George, Kingsport, TN (US)

Correspondence Address: TAMMYE TAYLOR, EASTMAN CHEMICAL COMPANY, 100 N. EASTMAN RD., KINGSPORT, TN, 37660-5075, US

(73) Assignee: EASTMAN CHEMICAL COMPANY, Kingsport, TN (US)

(21) Appl. No.: 11/959,568

(22) Filed: Dec. 19, 2007

(51) Int. Cl. C11D 3/00; C08G 63/68

(52) U.S. Cl. 510/515; 528/295

(57) ABSTRACT

A polyester textile softening agent comprising the reaction product of from about 1 to about 99 mole %, based on the total mole % of hydroxyl equivalents, of at least one glycol having a number average molecular weight of less than about 300 grams/mole; a difunctional sulfomonomer containing at least one metal sulfonate group bonded to an aromatic ring wherein the functional groups are ester, carboxyl, or hydroxyl in an amount to provide water dispersibility to the polyester; from about 1 to about 99 mole % a diacid other than a sulfomonomer; and from about 99 to about 1 mole % of a second glycol having a number average molecular weight greater than about 300 grams/mole. An aqueous dispersion comprising the textile softening agent and amount of water sufficient to disperse the textile softening agent is also disclosed.

### FIELD OF THE INVENTION

The present invention relates to a polyester composition that may be used as a textile softening agent. More particularly, the present invention relates to a polyester textile softening agent that includes residues from two distinct molecular weight glycols, a diacid and a sulfodiacid.

### BACKGROUND OF THE INVENTION

Compositions suitable for providing fabric softening and static control benefits during laundering are well known in the art. Typically, such compositions contain, as the softening component, a substantially water insoluble quaternary ammonium compound having two long alkyl chains. For example, U.S. Pat. No. 4,339,391 to Hoffmann, et al. discloses a series of quaternized ester-amines which have utility as fabric softeners; U.S. Pat. No. 4,767,547 discloses fabric softening compositions containing a rapidly biodegradable quaternary ammonium softening agent; and U.S. Pat. No. 6,770,608 to Franklin et al. discloses a textile softening composition having a mixture of mono-, di- and tri-ester quaternary ammonium salt components, wherein the amount of diester quaternary is greater than about 55% by weight, and the amount of triester quaternary is less than about 20% by weight based on the total amount of quaternary ammonium salt.

While the waxy hydrophobic nature of these types of fabric softeners imparts softness and lubricity to the fabrics, it can also diminish the water absorbency of certain textiles, such as towels or terry cloth.

It is common in the textile industry to use as sizing materials high molecular weight polymers that can be easily removed by washing. However, yarns made from polyester fibers based upon polyethylene terephthalate are not suitably sized with these conventional sizing materials and require a synthetic sizing material having suitable adhesion to the synthetic fiber as exemplified by those taught in U.S. Pat. No. 3,546,008. U.S. Pat. No. 3,546,008 discloses a copolyester containing the residue of a 5-sodio-sulfoisophthalic acid. This polyester is disclosed as useful as a sizing composition on a textile yarn such as a yarn made from poly(ethylene terephthalate). Such sizing compositions have found acceptance especially for the sizing of textile yarns where difficulties have been experienced in adhering conventional sizing materials thereto. The size compositions of the '008 patent are prepared using at least one difunctional dicarboxylic acid sulfomonomer containing a —SO₃ M group attached to an aromatic nucleus wherein M is hydrogen or a metal.

U.S. Pat. No.3,018,272 also discloses using a polyester having the —SO₃ M group where M is a metal functions as a basic dye sensitizing unit to permit the fibers to be readily dyed using basic dyes. The basic dye sensitizing unit is substituted on either an alkylene radical or an arylene radical. The polyesters disclosed are apparently not water-dispersible.

U.S. Pat. No.4,215,026 discloses a polyester size composition having from 5 to 50 mole percent of at least one carboxylic acid monomer containing the —SO₃ M group or mixtures thereof; about 95 to about 50 mole percent of at least one aromatic or aliphatic dicarboxylic acid or mixtures thereof and about 100 mole percent of at least one diol or polyglycol or mixtures thereof. The ease of dispersibility of the polyester size is directly related to the amount of the carboxylic acid or ester derivative of a monomer or monomers containing the —SO₃ M group.

U.S. Pat. Publication No. 2003/0124367 published Jul. 3, 2003 discloses a block copolymer composition comprising a polyester-polyether prepared from the reaction products of: (i) a diacid which is other than a sulfomonomer; (ii) optionally, 0.05 to 5 mole %, based on the total mole % of all carboxyl, ester, and hydroxyl equivalents, of at least one difunctional sulfomonomer containing at least one metal sulfonate group bonded to an aromatic ring wherein the functional groups are ester, carboxyl, or hydroxyl; (iii) 5 to 50 mole %, based on the total mole % of hydroxyl equivalents, of at least one polyethylene glycol having the structure H—(OCH₂CH₂)ₙ—OH where n is from 22 to 80 and (iv) from greater than 50 to less than 95 mole %, based on the total moles of hydroxyl equivalents, of a glycol or mixture of glycols that are other than a polyethylene glycol.

However, none of the prior cited patents or publications utilizing a carboxylic acid monomer containing the —SO₃ M group disclose a composition that would be useful as a textile softening agent.

### SUMMARY OF THE INVENTION

Briefly, the present invention relates to water-dispersible sulfopolyesters having improved water-dispersibility that are useful as a fabric softener for textiles. Such sulfopolyesters have an acid component that contains a dicarboxylic acid, a sulfomonomer, if the sulfomonomer is present in acid form, a relatively low molecular weight glycol component and a relatively high molecular weight glycol component. Methods for preparing the softening agent are also within the scope of the invention.

### DETAILED DESCRIPTION OF THE INVENTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

The present invention provides a block copolyester composition comprising a polyester prepared from the reaction products of: (a) from about 1 to about 99 mole %, based on the total mole % of hydroxyl equivalents, of at least one glycol having a number average molecular weight of less than about 300 grams/mole; (b) a difunctional sulfomonomer containing at least one metal sulfonate group bonded to an aromatic ring wherein the functional groups are ester, carboxyl, or hydroxyl in an amount to provide water dispersibility to the polyester; (c) from about 1 to about 99 mole % a diacid other than a sulfomonomer; and (d) from about 99 to about 1 mole % of a second glycol having a number average molecular weight greater than about 300 grams/mole.

The polyester of the present invention comprised substantially of equal molar proportions of acid equivalents (100 mole %) and glycol equivalents (100 mole %) and wherein the inherent viscosity is at least 0.1 dL/g as measured in a 60/40 parts by weight solution of phenol/tetrachloroethane at 25° C. at a concentration of about 0.25 g of polymer in 100 mL of the solvent. Preferably, the inherent viscosity is at least 0.25 dL/g, more preferably 0.3 dL/g.

Component (a) is a diol and desirably a glycol having a molecular weight of less than about 300 grams/mole and may be aliphatic, alicyclic, aralkyl or alkyl ether. Suitable low molecular weight diols include, but are not limited to, ethylene glycol; 1,2-propanediol; 1,3-propanediol, 2,2-dimethyl-1,3-propanediol; 2-ethyl-2-butyl-1,3-propanediol; 1,4-butanediol; 1,5-pentanediol; 1,6-hexanediol; 1,8-octanediol; 1,10-decanediol; 1,12-dodecanediol; 1,4-cyclohesanedimethanol; 1,3-cyclohexanedimethanol; 2,2,4,4-tetramethyl-1,3-cyclobutanediol; p-Xylylenediol; diethylene glycol, triethylene glycol; tetraethylene glycol; pentaethylene glycol; hexaethylene glycol; heptaethylene glycol; dipropylene glycol; tripropylene glycol; dibutylene glycol; ethylene propylene glycol and mixtures thereof.

Preferably, the diol component (a) is an alkylene glycol having a number average molecular weight of less than about 300 g/mole selected from poly(alkylene glycol) having the general formula:

H—(OCH₂CH₂)ₙ—OH

wherein n is from 2 to 6 and is present in an amount of from about 25 to about 80 mole %, and more preferably from about 35 to about 80 mole % of the total hydroxyl content of the polyester. The polyethylene glycol component provides hydrophilic, but non-ionic, moieties within the sulfopolyester backbone.

In another embodiment, the low molecular weight diol is a mixture of polyethylene glycol and a second low molecular weight glycol that is more hydrophobic than the PEG component to provide the best combination of dispersibility at a Tg greater than 25° C. For example, suitable hydrophobic glycols include aliphatic, alicyclic and aralkyl glycols and comprise greater than about 10 mole % to less than about 75 mole % of the total mole % of the low molecular weight hydroxyl equivalents. More preferably, the hydrophobic glycol component comprises from about 20 to about 50 mole % of the total mole % of the low molecular weight hydroxyl equivalents. Examples of these glycols include ethylene glycol; propylene glycol; 1,3-propanediol; 2,4-dimethyl-2-ethyl-hexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol-; 1,3-cyclohexane dimethanol; 1,4-cyclohexanedimethanol; 2,2,4,4-tetramethyl-1,3-cyclobutanediol; p-xylylenediol and mixtures thereof.

The difunctional sulfomonomer which provides water-dispersibility to the water-dispersible sulfopolyesters of the invention is selected from a dicarboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring. The difunctional sulfomonomer, may advantageously be a dicarboxylic acid or ester thereof containing a sulfonate group (—SO₃ M) or a diol containing a sulfonate group derived from the reaction product of a dicarboxylic acid or ester thereof with a glycol. The cation of the sulfonate salt may be a metal ion, such as Li⁺, Na⁺, K⁺, Mg⁺⁺, Ca⁺⁺, Cu⁺⁺, Ni⁺⁺, Fe₊₊₊ and the like.

It is within the boundaries of this disclosure that the sulfonate salt is non-metallic and may include a nitrogenous base as described in U.S. Pat. No. 4,304,901, the disclosure of which is herein incorporated by reference or a phosphonium salt. Suitable nitrogen based cations are derived from nitrogen containing bases, which may be aliphatic, cycloaliphatic, or aromatic compounds that have ionization constants in water at 25° C. of 10⁻³ to 10⁻¹⁰, preferably 10⁻⁵ to 10⁻⁸. Examples of suitable nitrogen containing bases are ammonia, pyridine, morpholine, and piperidine.

In another embodiment, the sulfonate salt includes a phosphonium salt having the general formula:

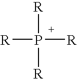

wherein R is as defined above.

An advantage of the phosphonium salt is its similarity to the quaternary ammonium composition where the cationic heteroatom is bonded to hydrophobic groups that can impart softness to the textile. Optionally, the sulfopolyester of the present invention may include different cations.

The choice of cation can influence, often markedly, the water-dispersibility of the resulting polymer. Depending on the end-use application of the polymer, either a more or less easily dispersible product may be desired. It is possible to prepare the sulfopolyester using, for example, a sodium sulfonate salt and then by ion-exchange methods replace the sodium with a different ion as discussed above, when the polymer is in the dispersed form. This type of ion-exchange procedure is generally superior to preparing the polymer with divalent and trivalent salts inasmuch as the sodium salts are usually more soluble in the polymer reactant melt-phase. Also, the ion-exchange procedure is usually necessary to obtain the phosphonium and nitrogenous counter-ions.

Preferred difunctional sulfomonomers are those where the sulfonate salt group is attached to an aromatic acid nucleus, such as benzene, naphthalene, diphenyl, oxydiphenyl, sulfonyldiphenyl, or methylenediphenyl. More preferably, the sulfomonomer is selected from sulfophthalic acid, sulfoterephthalic acid, sulfoisophthalic acid, 4-sulfonaphthalene-2,7-dicarboxylic acid, their esters and mixtures thereof as described in U.S. Pat. No. 3,779,993, the disclosure of which is incorporated herein by reference. Even more preferably, the difunctional sulfomonomer is 5-sodiosulfoisophthalic acid or esters thereof. It is preferred that the difunctional sulfomonomer be present in an amount of about 6 to about 40 mole %, more preferably about 8 to about 35 mole %, and most preferably about 9 to about 15 mole %, based on the total acid equivalents.

A process for preparing the sulfopolyesters of the present invention involves two distinct stages, an ester-interchange or esterification stage and a polycondensation stage. The ester-interchange or esterification, is conducted under an inert atmosphere at a temperature of about 150 to about 250° C. for 0.5 to 8 hours, preferably from about 180 to about 230° C. for 1 to 4 hours. The difunctional sulfomonomer is normally added directly to the reaction mixture from which the polymer is made. Other processes are known and may also be employed. Illustrative examples from the art are U.S. Pat. Nos. 3,018,272; 3,075,952; and 3,033,822, the disclosures of which are herein incorporated by reference. The glycols are commonly used in molar excesses of about 1.05 to about 2.5 moles per total moles of acid-functional monomers. Preferably, the esterification reaction is conducted at pressures greater than ambient or atmospheric. In either situation an inert atmosphere, such as nitrogen or argon, will provide superior results. The second stage, referred to as polycondensation, is conducted under reduced pressure at a temperature of about 230 to about 350° C., preferably about 240 to about 310° C., and more preferably about 250 to about 290° C. for 0.1 to 6 hours, preferably 0.25 to 2 hours. Stirring or appropriate conditions are used in both stages to ensure adequate heat transfer and surface renewal of the reaction mixture.

The sulfopolyesters are preferably prepared using a buffer. Buffers and their use are well known in the art and one of ordinary skill in the art is well acquainted with their use to prepare sulfopolyesters. Examples of suitable buffers include but are not limited to sodium acetate, potassium acetate, lithium acetate, sodium phosphate monobasic, potassium phosphate dibasic or sodium carbonate. The buffer is present in an amount of up to about 0.2 moles per mole of difunctional sulfomonomer. Preferably, the buffer is present in an amount of about 0.1 moles per mole of difunctional sulfomonomer.

The reactions of both stages are facilitated by appropriate catalysts, especially those well-known in the art and taught, for example, by U.S. Pat. Nos. 4,167,395 and 5,290,631, the disclosures of which are hereby incorporated by reference. Suitable catalysts include, but are not limited to, alkoxy titanium compounds, alkali metal hydroxides and alcoholates, salts of organic carboxylic acids, alkyl tin compounds, metal oxides, and so forth. When terephthalic acid is used as one of the starting materials, the esterification stage may be autocatalytic. A three-stage manufacturing procedure, similar to the disclosure of U.S. Pat. No. 5,290,631, the disclosure of which is herein incorporated by reference, may also be used, particularly when a mixed monomer feed of acids and esters is employed. Multi-staging is also a useful method to control the glycol composition, as described supra, where ethylene, diethylene, triethylene, etc. are interconverted via adventitious side reactions.

In accordance with the present invention the sulfocopolyester includes a second or additional diacid, other than the sulfomonomer. The dicarboxylic acid that is not a sulfomonomer constitutes from about 1 to about 99 mole % of the total moles of acid. Preferably the dicarboxylic acid that is not a sulfomonomer constitutes from about 15 to about 85 mole %, and more preferably from about 25 to about 75 mole %, based on of the total moles of acid or acid equivalents used in the polyester. It is to be understood that the use of the corresponding acid anhydrides, esters, and acid chlorides is included in the term “dicarboxylic acid”. Examples of suitable diacids include aliphatic diacids, alicyclic dicarboxylic acids, aromatic dicarboxylic acids, or mixtures of two or more of these acids. Although not limiting, suitable dicarboxylic acids include succinic; glutaric; adipic; azelaic; sebacic; fumaric; maleic; itaconic; 1,3-cyclohexane dicarboxlic; 1,4-cyclohexanedicarboxylic; diglycolic; 2,5-norbornanedicarboxylic; phthalic; terephthalic; 1,4-naphthalenedicarboxylic; 2,5-naphthalenedicarboxylic; 2,6-naphthalenedicarboxylic; 2,7-naphthalenedicarboxylic; diphenic; 4,4′-oxydibenzoic; 4,4′-sulfonyldibenzoic; and isophthalic. Terephthalic acid and isophthalic acid are preferred diacids. Compared to acid chlorides and acid anhydrides, dimethyl esters are preferred and it is also acceptable to include higher order alkyl esters, such as ethyl, propyl, isopropyl, butyl, and so forth in the preparation of the polyester-polyethers. In addition, aromatic esters, particularly phenyl, may also be considered.

Component (d) of the present invention is a relatively high molecular eight polyalkylene glycol having a number average molecular weight greater than about 300 g/mole selected from glycols having the general formulae:

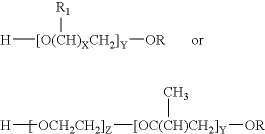

wherein X is an integer from 1 to 6, Y is an integer from 7 to 250, Z is an integer from 1 to 20 and R and R1 are independently selected from hydrogen or alkyl. As used herein “alkyl” means a straight or branched carbon chain having from 2 to 18 carbons atoms. Suitable examples include, but are not limited to, aliphatic, alicyclic, and aralkyl glycols selected from ethylene glycol; propylene glycol; 1,3-propanediol; 2,2-dimethyl-1,3-propanediol; 2-ethyl-2-butyl-1,3-propanediol; 1,3-butanediol; 1,4-butanediol; 1,5-pentanediol; 1,6-hexanediol; 1,2-cyclohexanedimethanol; 1,3-cyclohexanedimethanol; 1,4-cyclohexanedimethanol; 2,2,4,4-tetramethyl-1,3-cyclobutanediol, and p-ylylenediol. Commercially available polyethylene products may be obtained from the Dow Chemical Company under the trademark CARBOWAX®, and polypropylene glycols and polytetramethylene glycols may be obtained from Invista, Inc. under the trademark TETRATHANE®. Other compounds include ethylene oxide-b-propylene oxide such as UCON® available from Dow Chemical Company, poly(ethylene-b-propylene glycol-b-ethylene glycol) and poly(ethylene glycol-ran-propylene glycol), wherein “b” and “ran” represent a block residue of the respective moiety.

As described above, diethylene glycol, triethylene glycol, tetraethylene glycol, and so forth may also be included in the polymer composition. It is important to recognize that certain glycols may be formed in situ due to side reactions that may be controlled by varying the process conditions. For example, varying proportions of diethylene, triethylene, and tetraethylene glycols may be formed from ethylene glycol or mixtures of ethylene glycol with other glycols due to an acid-catalyzed dehydration, which occurs readily when a buffer is not added to raise the pH of an acidic reaction mixture.

The amount of the relatively high molecular weight glycol utilized in the sulfocopolyester is the remainder of the diol based on the total mole % of hydroxyl equivalents which in total equals 100 mole %. Preferably the amount of the relatively high molecular weight glycol utilized in the sulfocopolyester is from about 99 to about 1 mole %, and more preferably from about 0.1 to about 50 mole %, and most preferably from about 1 to about 30 mole %, based on the total mole % of hydroxyl equivalents which in total equals 100 mole %.

The higher order polyalkylene glycols may possess secondary hydroxyl groups that are not as desirable as primary hydroxyls for polyester forming reactions due to decreased reactivity. It is not deleterious to the practice of this invention to use end-capping procedures that convert secondary hydroxyls to primary hydroxyl end groups. Illustrative of this technique is where ethylene oxide is used to end-cap higher molecular weight polypropylene glycols to yield poly(ethylene-b-propylene-b-ethylene) glycols. The molecular weight and the mole % of the higher order polyalkylene glycol are inversely proportional to each other. As the molecular weight is increased the mole % of the higher order polyalkylene glycol will be decreased. For example, a higher order polyalkylene glycol having a molecular weight of 500 may constitute up to about 30 mole % of the total glycol, while a higher order polyalkylene glycol having a molecular weight of about 10,000 would typically be incorporated at a level of about one mole % or less of the total glycol in the sulfopolyester. The lower molecular weight higher order polyalkylene glycols, which have molecular weights of less than about 500 g/mole may constitute up to about 50% mole % of the total glycol in the sulfopolyester.

To obtain the polymers of this invention, all of the components, including the difunctional sulfomonomer, can be added together at the start of the reaction from which the polymer is synthesized. Other processes are known and they may also be employed. Illustrative examples from the art include U.S. Pat. Nos. 3,018,272; 3,075,952; and 3,033,822, incorporated herein by reference. These patents disclose interchange reactions as well as polymerization processes. The glycols, depending on their reactivities and the specific experimental conditions employed, are normally used in molar excesses of about 1.05 to about 3 moles per total moles of acid-functional monomers. The reactions of both stages are facilitated by appropriate catalysts, especially those known in the art, such as alkoxy titanium compounds, alkali metal hydroxides and alcoholates, salts of organic carboxylic acids, alkyl tin compounds, metal oxides, and so forth. A three-stage manufacturing procedure, similar to the teachings of U.S. Pat. No. 5,290,631, incorporated herein by reference, may also be used, particularly when a mixed monomer feed of acids and esters is employed.

In another embodiment, the polyester fabric softener may further include crystalline polyesters. While there is not a preference in regard to dissipative performance as a fabric softener, compositions possessing at least some crystallinity may be useful since they will be more resistant to cold-flow. One of the benefits of crystallinity is that a convenient product form (i.e., pellets) may be possible. This is particularly important in the context of the present invention because the levels of PEG that are required often result in Tg values below room temperature. Therefore, amorphous low Tg compositions may be difficult to package in a free-flowing product form, which may hamper subsequent processing operations, such as feeding into an extruder. For this reason, crystalline compositions having at least one melting point (Tm) from about 30° C. to about 50° C. are desired.

The compounds in accordance with the invention are suitable for use as fabric softeners and are added to the last rinsing bath after the washing of the textile material in the form of aqueous dispersions containing from about 1 to about 15, generally about 4 to about 10, weight % of the sulfopolyester. Subsequently, the textile material is dried. These fabric softeners may also contain from about 0.5 to about 75 weight % of at least one other additive or auxiliaries which are conventionally used in softening compositions, they include, for example, cationic and nonionic surface-active substances, electrolytes, neutralizing agents, organic complexing agents, optical brighteners, solubilizers, dyestuffs and perfumes. Additives of this kind may serve various purposes, for example, they may further influence the feel of the fabric or provide other properties to the textile goods that are treated, they adjust the viscosity or pH, or they may further promote the stability of the solutions at low temperatures. Although the stability of the textile softening compositions of the present invention is such that stabilizing co-surfactants are not required, they may nevertheless be included along with a wide variety of other optional ingredients. A brief non-limiting description of some of the optional ingredients which may be employed in the textile softening compositions of the present invention is provided below.

Surfactant concentration aids typically fall into four categories: (1) mono long chain alkyl cationic surfactants; (2) nonionic surfactants; (3) amine oxides; and (4) fatty acids.

Preferred mono-long chain alkyl or ester based water-soluble cationic surfactants generally fall within the scope of the following general formula:

[R₂N⁺(R₃)]X⁻

wherein the R₂ is a C₈-C₂₂ hydrocarbon group, preferably a C₁₂-C₁₈ alkyl group or the corresponding ester linkage interrupted group with a short chain alkylene (C₁-C₆) group between the ester linkage and the nitrogen, and having a similar hydrocarbon group. Each R is a C₁-C₆ unsubstituted or substituted alkyl (e.g., by hydroxy) or hydrogen, preferably methyl, and the counterion X⁻ is a softener compatible anion such as, for example, chloride, bromide, or methyl sulfate. The cationic surfactants, if present, are usually added to solid compositions at a level up to about 15%, preferably from about 3% to about 15%, more preferably from about 5% to about 15%. In liquid compositions they are usually employed at level of from about 0.5% to about 10%. In general, the total single-long-chain cationic surfactant is added in an amount effective to obtain a stable composition.

The long chain group R₂, of the single-long-chain-alkyl cationic surfactant generally contains an alkylene group having from about 10 to about 22 carbon atoms, preferably from about 12 to about 16 carbon atoms for solid compositions, and preferably from about 12 to about 18 carbon atoms for liquid compositions. This R₂ group can be attached to the cationic nitrogen atom through a group containing one, or more, ester, amide, ether, amine, etc., preferably ester, linking groups which can be desirable for increased hydrophilicity, biodegradability. Such linking groups are preferably within about three carbon atoms of the nitrogen atom. Suitable biodegradable single-long-chain alkyl cationic surfactants containing an ester linkage in the long chain are described in U.S. Pat. No. 4,840,738 which is incorporated herein by reference. The composition is buffered (pH from about 2 to about 5, preferably from about 2 to about 4) to maintain an appropriate, effective charge density in the aqueous liquid concentrate product and upon further dilution e.g., to form a less concentrated product and/or upon addition to the rinse cycle of a laundry process

The main function of the water-soluble cationic surfactant is to lower the viscosity and/or increase the dispersibility of the diester softener and it is not, therefore, essential that the cationic surfactant itself have substantial softening properties, although this may be the case. Also, surfactants having only a single long alkyl chain, presumably because they have greater solubility in water, can protect the diester softener from interacting with anionic surfactants and/or detergent builders that are carried over into the rinse.

Nonionic surfactants suitable as viscosity/dispersibility modifiers include the addition products of ethylene and/or propylene oxide with fatty alcohols, fatty acids, fatty amines, etc. Any of the alkoxylated materials hereinafter described can be used as the nonionic surfactant. In general terms, the nonionics herein can be employed in solid compositions at a level of from about 5% to about 20%, preferably from about 8% to about 15%, and in liquid compositions at a level of from 0% to about 5%, preferably from about 0.1% to about 5%, more preferably from about 0.2% to about 3%.

The nonionic surfactants that may be used are characterized by an HLB (hydrophilic-lipophilic balance) from about 7 to about 20, preferably from about 8 to about 15. By defining R₂ and the number of ethoxylate groups, the HLB of the surfactant is, for the most part, determined. However, it is preferred that for concentrated liquid compositions, the nonionic surfactants contain relatively long chain R₂ groups and are relatively highly ethoxylated. While shorter alkyl chain surfactants with short ethoxylated groups may have the requisite HLB, they typically are not as effective.

Nonionic surfactants employable in the present invention include but are not limited to the following examples. In these examples, the number of ethoxyl groups in the molecule (EO) is defined by an integer.

(i) Straight-Chain, Primary Alcohol Alkoxylates

The deca-, undeca-, dodeca-, tetradeca-, and pentadeca-ethoxylates of n-hexadecanol, and n-octadecanol having an HLB within the preferred range are useful as viscosity/dispersibility modifiers of the context of this invention. Preferred examples of ethoxylated primary alcohols useful herein as the viscosity/dispersibility modifiers of the compositions include but are not limited to n-C₁₈ EO(10); and n-C₁₀ EO(11). The ethoxylates of mixed natural or synthetic alcohols in the “tallow” chain length range are also useful herein. Specific examples of such materials include tallow alcohol-EO(11), tallow alcohol-EO(18), and tallow alcohol-EO(25).

(ii) Straight-Chain, Secondary Alcohol Alkoxylates

The deca-, undeca-, dodeca-, tetradeca-, pentadeca-, octadeca-, and nonadeca-ethoxylates of 3-hexadecanol, 2-octadecanol, 4-eicosanol, and 5-eicosanol having an HLB within the preferred range are useful viscosity/dispersibility modifiers in the context of the present invention. Examples of ethoxylated secondary alcohols useful herein as the viscosity/dispersibility modifiers of the compositions include but are not limited to: 2-C₁₆ EO(11); 2-C₂₀ EO(11); and 2-C₁₆ EO(14).

(iii) Alkyl Phenol Alkoxylates

As is the case of the alcohol alkoxylates, the hexa- through octadeca-ethoxylates of alkylated phenols, particularly monohydric alkylphenols, having an HLB within the preferred range are useful as the viscosity/dispersibility modifiers. The hexa- through octadeca-ethoxylates of p-tridecylphenol, m-pentadecylphenol, and the like, are useful herein. Preferred examples of ethoxylated alkylphenols useful as the viscosity-dispersibility modifiers include but are not limited to: p-tridecylphenol EO(11) and p-pentadecylphenol EO(18).

It would be generally recognized by one of ordinary skill in the art that a phenylene group in the nonionic formula is the equivalent of an alkylene group containing from 2 to 4 carbon atoms. For present purposes, nonionic surfactants containing a phenylene group are considered to contain an equivalent number of carbon atoms calculated as the sum of the carbon atoms in the alkyl group plus about 3.3 carbon atoms for each phenylene group.

(iv) Olefinic Alkoxylates

The alkenyl alcohols, both primary and secondary, and alkenyl phenols corresponding to those disclosed hereinabove can be ethoxylated to an HLB within the range recited herein and used as the viscosity/dispersibility modifiers in the compositions of the present invention

(v) Branched Chain Alkoxylates

Branched chain primary and secondary alcohols which are available from the well-known “OXO” process can be ethoxylated and employed as the viscosity/dispersibility modifiers in the present compositions.

The ethoxylated nonionic surfactants summarized hereinabove can be usefully employed in the present compositions either alone or in specific mixtures.

(3) Amine Oxides

Suitable amine oxides include but are not limited to those with one alkyl or hydroxyalkyl moiety of about 8 to about 28 carbon atoms, preferably from about 8 to about 16 carbon atoms, and two alkyl moieties selected from the group consisting of alkyl groups and hydroxyalkyl groups with about 1 to about 3 carbon atoms. Amine oxides, if employed, are generally present in solid compositions at a level of from 0% to about 15%, preferably from about 3% to about 15%; and in liquid compositions at a level of from 0% to about 5%, preferably from about 0.25% to about 2%. The total amount amine oxide is generally present in an amount effective to provide a stable composition. Preferred examples of amine oxides employable in the present invention include but are not limited to dimethyloctylamine oxide, diethyldecylamine oxide, bis-(2-hydroxyethyl)dodecylamine oxide, dimethyl dodecylamine oxide, dipropyltetradecylamine oxide, methylethylhexadecylamine oxide, dimethyloctadecylamine oxide, di(2-hydroxyethyl)octyldecylamine oxide and coconut fatty alkyl dimethylamine oxide.

Suitable fatty acids include those containing from about 12 to about 25, preferably from about 13 to about 22, more preferably from about 16 to about 20, total carbon atoms, with the fatty moiety containing from about 10 to about 22, preferably from about 10 to about 18, more preferably from about 10 to about 14 carbon atoms. Fatty acids are typically present at approximately the levels outlined above for amine oxides.

Electrolyte Concentration Aids

Inorganic viscosity control agents which can also act like or augment the effect of the surfactant concentration aids include water-soluble, ionizable salts. Such salts can also optionally be incorporated into the compositions of the present invention. A wide variety of ionizable salts can be used. Examples of suitable salts include but are not limited to the halides of the Group IA and IIA metals of the Periodic Table of Elements, e.g., calcium chloride, magnesium chloride, sodium chloride, potassium bromide, and lithium chloride. The ionizable salts are particularly useful during the process of mixing the ingredients to make the compositions herein, and to obtain the desired viscosity. The amount of ionizable salts used depends on the amount of active ingredients used in the compositions. Typical levels of salts used to control the composition viscosity are from about 20 to about 20,000 parts per million (ppm), preferably from about 20 to about 11,000 ppm, by weight of the composition.

Alkylene polyphosphonium salts can be incorporated into the composition to give viscosity control in addition to, or in place of, the water-soluble, ionizable salts described above. Additionally, these agents can act as scavengers, forming ion pairs with anionic detergent carried over from the main wash to the rinse and may improve softening performance. These agents may stabilize the viscosity over a broader range of temperature, especially at low temperatures, compared to the inorganic electrolytes.

Stabilizers may also be optionally employed in the compositions of the present invention. The term “stabilizer,” as used herein, includes antioxidants and reductive agents. These agents are typically present at levels of from 0% to about 2%, preferably from about 0.01% to about 0.2%, more preferably from about 0.05% to about 0.1% for antioxidants and more preferably from about 0.01% to about 0.2% for reductive agents. Stabilizer use assures good odor stability under long term storage conditions. Further, use of antioxidants and reductive agent stabilizers is especially critical for unscented or low scent products.

Examples of antioxidants which can be employed in the compositions of the present invention include but are not limited to a mixture of ascorbic acid, ascorbic palmitate, propyl gallate, available from Eastman Chemical Products, Inc., under the trade names Tenox® PG and Tenox S-1; a mixture of BHT (butylated hydroxytoluene), BHA (butylated hydroxyanisole), propyl gallate, and citric acid, available from Eastman Chemical Products, Inc., under the trade name Tenox-6; butylated hydroxytoluene, available from UOP Process Division under the trade name Sustane® BHT; tertiary butylhydroquinone available from Eastman Chemical Products, Inc. under the mark Tenox® TBHQ; natural tocopherols available from Eastman Chemical Products, Inc. under the mark Tenox® GT-1/GT-2; and butylated hydroxyanisole available from Eastman Chemical Products, Inc., as BHA; long chain esters (C.sub.8-C.sub.22) of gallic acid such as dodecyl gallate; Irganox® 1010; Irganox® 1035; Irganox® B 1171; Irganox® 1425; Irganox® 3114; Irganox® 3125; and mixtures thereof; or in combination with citric acid and/or EDTA or other chelators such as isopropyl citrate, Dequest® 2010 available from Monsanto under the name 1-hydroxyethylidene-1,1-diphosphonic acid (etidronic acid), Tiron®, available from Kodak with a chemical name of 4,5-dihydroxy-m-benzene-sulfonic acid/sodium salt, and DTPA® (diethylenetriaminepentaacetic acid), available from Aldrich.

Examples of reductive agents include but are not limited to sodium borohydride, sodium bisulfite, hypophosphorous acid, and mixtures thereof. The stability of the compounds and compositions herein can be improved by use of stabilizers, but the preparation of compounds used herein and the source of hydrophobic groups also can be important. Surprisingly, some highly desirable, readily available sources of hydrophobic groups such as fatty acids from, e.g., tallow, possess odors that remain with the compound despite the chemical and mechanical processing steps which convert the raw tallow to finished product. Such sources must be deodorized, e.g., by absorption, distillation, stripping, etc., as is well known in the art. In addition, contact of the resulting fatty acyl groups to oxygen and/or bacteria must be minimized by adding antioxidants, antibacterial agents.

The composition of the present invention may optionally contain from about 0.1% to about 10%, preferably from about 0.2% to about 5%, of a soil release agent. Preferably, the soil release agent is a polymeric soil release agent such as one which contains copolymeric blocks of terephthalate and polyethylene oxide or polypropylene oxide, cationic guar gums, and the like. U.S. Pat. No. 4,956,447, which is incorporated herein by reference, discloses some preferred soil release agents comprising cationic functionalities.

A preferred soil release agent is copolymer having blocks of terephthalate and polyethylene oxide which are comprised of repeating units of ethylene terephthalate and polyethylene oxide terephthalate at a molar ratio of ethylene terephthalate units to polyethylene oxide terephthalate units of from about 25:75 to about 35:65, said polyethylene oxide terephthalate containing polyethylene oxide blocks having molecular weights of from about 300 to about 2,000. The molecular weight of this polymeric soil release agent is in the range of from about 5,000 to about 55,000.

Cellulosic derivatives are also functional as soil release agents. Examples of such agents include but are not limited to hydroxyethers of cellulose such as Methocel® available from Dow Chemical; and certain cationic cellulose ether derivatives such as Polymer JU-125®, JR-400®, and JR-30M® available from Union Carbide. Additional examples of cellulosic polymeric soil release agents include methyl cellulose, hydroxypropyl methylcellulose, hydroxybutyl methylcellulose, or mixtures thereof wherein said cellulosic polymer has a viscosity in a 2% aqueous solution at 20° C. of about 15 to about 75,000 centiposie. Other effective soil release agents are cationic guar gums such as Jaguar Plus® available from Stein Hall and Gendrive 458® available from General Mills. A more complete disclosure of highly preferred soil release agents is contained in European Patent Application No. 185,427 to Gosselink which was published Jun. 25, 1986, and U.S. Pat. No. 5,207,933 to Trinh et al. which issued May 4, 1993, both of which are incorporated herein by reference.

Examples of bacteriocides which can be employed in the compositions of the present invention include but are not limited to parabens such as methyl, glutaraldehyde, formaldehyde, 2-bromo-2-nitropropane-1,3-diol sold by Inolex Chemicals under the trade name Bronopol®, and a mixture of 5-chloro-2-methyl-4-isothiazoline-3-one and 2-methyl-4-isothiazoline-3-one sold by Rohm and Hass Company under the trade name Kathon® CG/ICP. Typical levels of bacteriocides used in the present compositions are about 1 ppm to about 2,000 ppm by weight of the composition, depending on the type of bacteriocide selected. Methyl paraben is especially effective for mold growth in aqueous fabric softening compositions with under 10% by weight of the diester component.

Dimethylpolysiloxane (silicone) or modified silicone can be added to the composition of this present invention, in order to enhance the softening property and water-absorbency Dimethypolysiloxane or a modified silicone, having a viscosity of about 20 to about 10000 cps at 25° C., is preferred. Modified silicones useful in the present invention include, for example, polyoxyethylene modified silicone and amino-modified silicone, wherein the amount of the modification is preferably less than about 10%. It is preferable that dimethylpolysiloxane or modified silicones are emulsified with a polyoxyethylene-type nonionic surfactant or a monoalkylcationic-type or dialkylcationic-type cationic surfactant prior to their use.

The present invention is illustrated in greater detail by the example presented below. It is to be understood that the example is an illustrative embodiment and is not intended to be limiting of the invention, but rather is to be construed broadly within the scope and content of the appended claims. All parts and percentages in the examples are on a weight basis unless otherwise stated.

### EXAMPLE

In a 500 ml round bottom flask equipped with a ground glass joint, agitator shaft, nitrogen inlet, and a sidearm to allow for removal of volatile materials is charged with 87.3 grams (0.45 moles) of dimethyl terephtalate, 14.8 grams (0.05 moles) dimethyl-5-sodiosulfoisophthalate, 79.5 grams (0.75 moles) diethylene glycol, and 50 grams (0.05 moles) of poly(tetramethylene glycol) having a number average molecular weight of 1000 g/mole, 0.35 grams of Irganox 1010 antioxidant, and 1.3 mL of a 1.25% wt/vol solution of titanium(IV)isopropoxide in n-butanol. The flask is purged with nitrogen and immersed in a Belmont metal bath at 200° C. for 60 minutes then 220° C. for 120 minutes under a slow sweep of nitrogen with agitation at 100 RPM. After elevating the temperature to 260° C., the pressure is gradually reduced from 760 mm to 0.2 mm over the course of 15 minutes and held for another an additional 90 minutes for the polycondensation reaction to occur. The vacuum is displaced with nitrogen atmosphere and the polymer melt is allowed to cool to less than 200° C. before discharging into water heated to 90° C. with agitation. The molten polymer is added to the water over the course of 10 minutes to form a dispersion having a solids content of 20% by weight. A small sample of the solid polymer is analyzed for inherent viscosity and glass transition temperature.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

I claim:

1. A polyester textile softening agent comprising the reaction product of:
a. from about 1 to about 99 mole %, based on the total mole % of hydroxyl equivalents, of at least one glycol having a number average molecular weight of less than about 300 grams/mole;
b. a difunctional sulfomonomer containing at least one metal sulfonate group bonded to an aromatic ring wherein the functional groups are ester, carboxyl, or hydroxyl in an amount to provide water dispersibility to the polyester;
c. from about 1 to about 99 mole % a diacid other than a sulfomonomer; and
d. from about 99 to about 1 mole % of a second glycol having a number average molecular weight greater than about 300 grams/mole,
wherein the mole % of acid or acid equivalents is 100%, and the mole % of diol or diol equivalents is 100%.

2. The polyester of claim 1 wherein the component (a) is selected from the group consisting of ethylene glycol; 1,2-propanediol; 1,3-propanediol, 2,2-dimethyl-1,3-propanediol; 2-ethyl-2-butyl-1,3-propanediol; 1,4-butanediol; 1,5-pentanediol; 1,6-hexanediol; 1,8-octanediol; 1,10-decanediol; 1,12-dodecanediol; 1,4-cyclohesanedimethanol; 1,3-cyclohexanedimethanol; 2,2,4,4-tetramethyl-1,3-cyclobutanediol; p-Xylylenediol; diethylene glycol, triethylene glycol; tetraethylene glycol; pentaethylene glycol; hexaethylene glycol; heptaethylene glycol; dipropylene glycol; tripropylene glycol; dibutylene glycol; ethylene propylene glycol and mixtures thereof.

3. The polyester of claim 1 wherein the component (a) is an alkylene glycol having the general formula:
H—(OCH₂CH₂)ₙ—OH
wherein n is from 2 to 6 and is present in said polyester in an amount of from about 25 to about 80 mole %, based on the total hydroxy content of the polyester.

4. The polyester of claim 1 wherein the sulfomonomer component (b) is selected from the group consisting of sulfophthalic acid, sulfoterephthalic acid, sulfoisophthalic acid, 4-sulfonaphthalene-2,7-dicarboxylic acid, their esters and mixtures thereof.

5. The polyester of claim 4 wherein the sulfomonomer component (b) is present in the polyester in an amount of from about 6 to about 40 mole %, based on the total acid equivalents.

6. The polyester of claim 4 wherein the sulfomonomer component (b) is present in the polyester in an amount of from about 9 to about 15 mole %, based on the total acid equivalents.

7. The polyester of claim 1 wherein the additional dicarboxylic acid component (c) is selected from the group consisting of aliphatic diacids, alicyclic dicarboxylic acids, aromatic dicarboxylic acids, and mixtures thereof.

8. The polyester of claim 1 wherein the additional dicarboxylic acid component (c) is selected from the group consisting of succinic; glutaric; adipic; azelaic; sebacic; fumaric; maleic; itaconic; 1,3-cyclohexane dicarboxlic; 1,4-cyclohexanedicarboxylic; diglycolic; 2,5-norbornanedicarboxylic; phthalic; terephthalic; 1,4-naphthalenedicarboxylic; 2,5-naphthalenedicarboxylic; 2,6-naphthalenedicarboxylic; 2,7-naphthalenedicarboxylic; diphenic; 4,4′-oxydibenzoic; 4,4′-sulfonyldibenzoic; and isophthalic.

9. The polyester of claim 8 wherein the additional dicarboxylic acid component is present in the polyester in an amount of from about 15 to about 85 mole % based on the total moles of acid or acid equivalents.

10. The polyester of claim 1 wherein the second diol component (d) is selected from glycols having the general formulae: 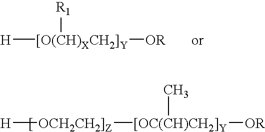
wherein X is an integer from 1 to 6, Y is an integer from 7 to 250, Z is an integer from 1 to 20 and R and R1 are independently selected from hydrogen or alkyl.

11. The polyester of claim 10 wherein the second diol component (d) is selected from the group consisting of ethylene glycol; propylene glycol; 1,3-propanediol; 2,2-dimethyl-1,3-propanediol; 2-ethyl-2-butyl-1,3-propanediol; 1,3-butanediol; 1,4-butanediol; 1,5-pentanediol; 1,6-hexanediol; 1,2-cyclohexanedimethanol; 1,3-cyclohexanedimethanol; 1,4-cyclohexanedimethanol; 2,2,4,4-tetramethyl-1,3-cyclobutanediol, p-xylylenediol, poly(ethylene-b-propylene glycol-b-ethylene glycol), poly(ethylene glycol-ran-propylene glycol) and mixtures thereof.

12. The polyester of claim 11 wherein the second diol component (d) is present in the polyester in amount of from about 0.1 to about 50 mole %, based on the total mole % of hydroxyl equivalents.

13. The polyester of claim 11 wherein the second diol component (d) is present in the polyester in amount of from about 1 to about 30 mole %, based on the total mole % of hydroxyl equivalents.

14. An aqueous dispersion comprising:
a. the polyester textile softening agent of claim 1; and
b. an amount of water sufficient to disperse component (a).

15. The dispersion of claim 14 wherein the amount of polyester textile softening agent is from about 1 to about 15 weight %.

16. The dispersion of claim 14 wherein the amount of polyester textile softening agent is from about 4 to about 10 weight %.

17. The dispersion of claim 14 further comprising at least one other additive selected from the group consisting of cationic and nonionic surface-active substances, electrolytes, neutralizing agents, organic complexing agents, optical brighteners, solubilizers, dyestuffs, and perfumes.
